(19) United States
(12) Patent Application Publication
(10) Pub. No.: US 2019/0005477 A1
(43) Pub. Date: Jan. 3, 2019

(54) POINT OF SALE PERIPHERAL CONTROL

(71) Applicant: HEWLETT-PACKARD DEVELOPMENT COMPANY, L.P., HOUSTON, TX (US)

(72) Inventor: AARON SANDERS, Houston, TX (US)

(21) Appl. No.: 15/748,960

(22) PCT Filed: Aug. 17, 2015
(86) PCT No.: PCT/US2015/045536

§ 371 Date: Jan. 30, 2018

(51) Int. Cl. G06Q 20/20; G06F 13/38; H04W 4/80

(52) U.S. Cl. CPC G06Q 20/20; H04W 4/80; G06F 13/385

(57) ABSTRACT

Examples associated point of sale peripheral control are disclosed. One example includes point of sale peripheral connectors to which point of sale peripheral devices are connected. The example also includes a remote device interface to communicate with remote devices that operate respective point of sale modules. The example also includes a point of sale peripheral control module to provide signals to and receive signals from the point of sale peripheral devices. The example also includes an interface module to translate signals between formats used by the point of sale peripheral devices and the remote devices.

### BACKGROUND

Point of sale systems are used in many different industries, including retail, restaurants, hotels and so forth. Point of sale systems can be used wherever goods or services can be exchanged for monetary value. The term point of sale generally refers to the retail store or location where such sales transactions occur. However, it can also refer to the equipment or devices used to facilitate such transactions. Thus, some retailers may operate several point of sale terminals each of which may be attached to numerous point of sale peripheral devices. Point of sale terminals, once a simple cash register and drawer, have evolved into computerized systems and sometimes are even embedded onto mobile devices such as tablets or other customized devices. Point of sale peripherals include barcode scanners, keyboards, cash drawers, and displays, among other devices that facilitate, for example, a clerk completing a sale transaction of a retailer's merchandise.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates an example interface associated with point of sale peripheral control.

FIG. 2 illustrates an example system associated with point of sale peripheral control.

FIG. 3 illustrates another example system associated with point of sale peripheral control.

FIG. 4 illustrates a flowchart of example operations associated with point of sale peripheral control.

FIG. 5 illustrates another flowchart of example operations associated with point of sale peripheral control.

FIG. 6 illustrates an example peripheral server associated with point of sale peripheral control.

FIG. 7 illustrates another example peripheral server associated with point of sale peripheral control.

FIG. 8 illustrates an example computing device in which example systems, and methods, and equivalents, may operate.

### DETAILED DESCRIPTION

Systems, methods, and equivalents associated with point of sale peripheral control are described. To process multiple transactions simultaneously, many retail stores have multiple points of sale at which, for example, merchandise may be exchanged for money. Sometimes these points of sale are organized around specific point of sale terminals which use point of sale peripherals to perform various tasks associated with transactions including displaying and receiving information, storing cash, and so forth. These types of point of sale terminals may be, for example, computers. Point of sale peripherals are may be connected to these computers using, for example, physical connections such as universal serial bus (USB) connectors, serial cables, and so forth.

Some stores have begun using mobile points of sale terminals using tablets, cell phones, custom terminals, and so forth. However, mobile point of sale terminals may not properly interface with certain types of legacy point of sale peripherals which communicate over physical connections. By way of illustration, many cell phones and tablets do not incorporate serial connectors or even USB connectors to which a point of sale peripheral can connect. Even if a mobile point of sale had this connection, physically attaching peripherals to a mobile device may defeat the purpose of using mobile point of sale terminals in the first place.

Consequently, point of sale peripherals may instead be attached to a device such as a server designed to serve as an interface between mobile devices and point of sale peripherals. The interface may include connectors, modules, and so forth that may translate commands received from point of sale devices to a format understandable to point of sale peripherals, as well as translating responses from the peripherals back into a format usable by the point of sale devices.

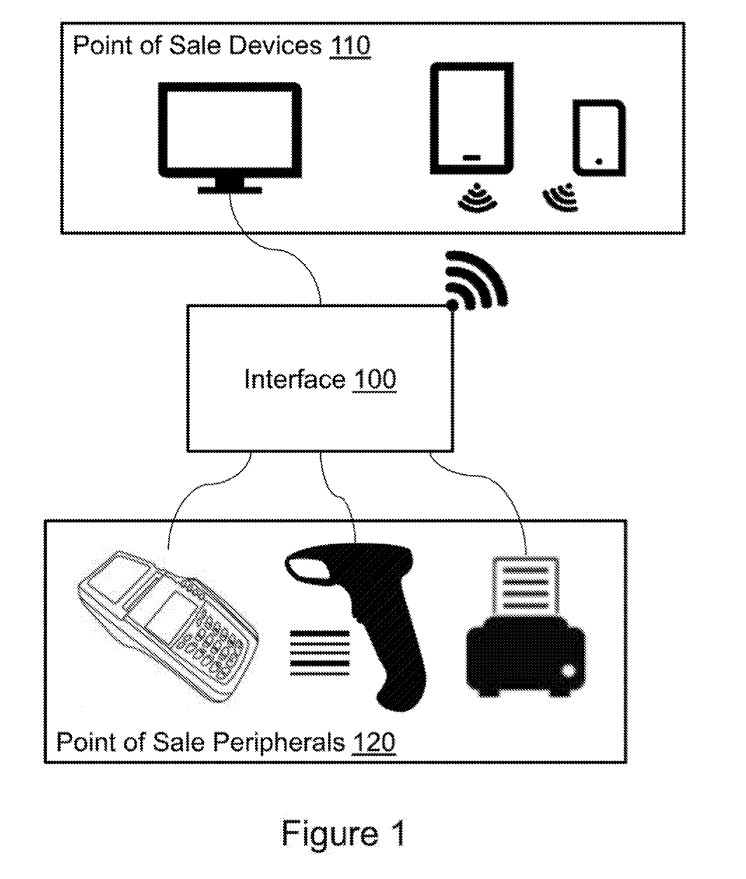

FIG. 1 illustrates an example interface associated with point of sale peripheral control. It should be appreciated that the items depicted in FIG. 1 are illustrative examples and many different devices, and so forth may operate in accordance with various examples.

FIG. 1 illustrates an example interface 100 associated with point of sale peripheral control. Interface 100 may interact as an intermediary between a set of point of sale devices 110 and a set of point of sale peripherals 120. In some examples, interface 100 may be a server that handles requests from point of sale devices 110 associated with point of sale peripherals 120, and transmits messages between point of sale devices 110 and point of sale peripherals 120. In various examples, interface 100 may also provide other services between point of sale device 110 and point of sale peripherals 120. For example, interface 100 may designate appropriate point of sale peripherals 120 depending on a request type, perform authentication and/or authorization, manage conflicts, and so forth.

Point of sale devices 110 may include, for example, the shown desktops, tablets, and phones, or other devices (not shown) including custom point of sale devices, and so forth. Point of sale devices 110 may communicate with interface 100 via a variety of technologies. As illustrated in this example, a desktop connects with interface 100 via a wired connection (e.g., universal serial bus, Ethernet) and a tablet and cell phone connect with interface 100 via a wireless connection (e.g., a wireless network, Bluetooth). The point of sale devices may run applications that are designed to perform retail transactions between a consumer and a retailer. The applications may allow the retailer to, for example, provide goods and/or services to a consumer while maintaining information regarding the transaction and performing other functions associated with the transaction (e.g., arithmetic).

Interface 100 may communicate with point of sale devices 110 using, for example, an application programming interface. This may allow, for example, an application to be installed on a point of sale device 110 that interprets signals received from interface 100 and convert them to data useful for consumption and/or interaction by a user of that point of sale device 110. The application may then, format commands from the user to the interface 100 or point of sale peripherals 120 according to that application programming interface so that interface 100 can properly interpret and effect the command. In some examples, the application programming interface may be device agnostic allowing many different types of applications to be built for different types of device 110 allowing functionalities to be built or added according to user interfaces and/or specifications of point of sale device 110, types of point of sale peripherals 120 being used, and so forth.

Point of sale peripherals 120 may include, for example, credit card readers, barcode scanners, receipt printers, as well as numerous unillustrated devices including displays, cash drawers, keyboards, and so forth. Point of sale peripherals are illustrated here as connecting to interface 100 via wired connections (e.g., universal serial bus, RS232) though wireless connections may also be possible.

As discussed above interface 100 may translate signals received from point of sale devices 110 (e.g., via the application programming interface) into a format used by point of sale peripherals 120. Interface 100 may also translate signals going in the opposite direction from peripherals 120 to devices 110. The format used by point of sale peripherals 120 may depend on the type of point of sale peripherals 120, how they are connected to interface 100, and so forth. In some examples, point of sale peripherals may be configured to operate according to a unified point of sale standard. Thus, signals received from point of sale devices 110 may be translated by interface 100 into the unified point of sale format so that control of point of sale peripherals 120 is possible. Similarly, signals received in the unified point of sale format from point of sale peripherals may be translated back into a format used by point of sale devices (e.g., using the application programming interface). It will be appreciated that other formats and standards may be used (e.g., when peripherals 120 use proprietary standards or formats) and in these cases translation may be performed in a manner appropriate to these standards and/or formats.

Consequently, interface 100 may allow use of many types of devices 110 that did not previously function with certain types of point of sale peripherals 120. By way of illustration because certain mobile devices lack certain types of input/output ports but may communicate, effectively over wireless networks, interface 100 may as an intermediary with the appropriate connections to connect devices 110 and peripherals 120. Further, retailers seeking to upgrade their point of sale infrastructure may be able to upgrade their points of sale without also replacing potentially expensive peripherals that will work with their new point of sale devices by using interface 100. Additionally, interface 100 may provide additional functionality including allowing sharing of peripherals 120 between multiple point of sale devices 110, as well as authentication and/or authorization services to prevent improper use of certain peripherals 120. Interface 100, when a device agnostic application programming interface is used, may also support transparent cross platform use of peripherals 120, potentially facilitating, for example, bring your own device solutions for retail services.

It is appreciated that, in the following description numerous specific details are set forth to provide a thorough understanding of the examples. However, appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

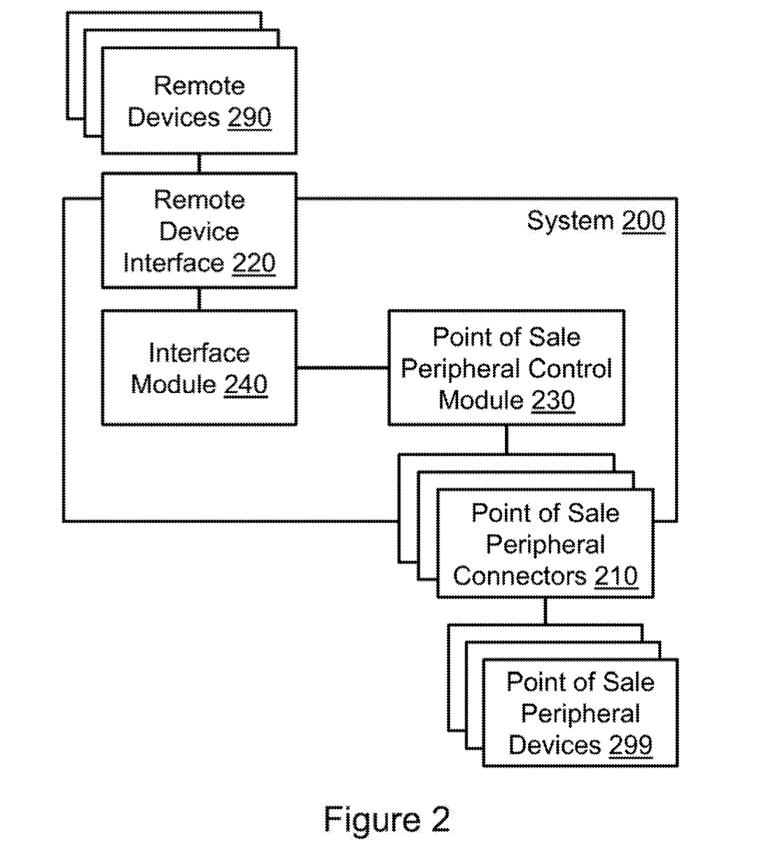

FIG. 2 illustrates an example system 200 associated with point of sale peripheral control. System 200 includes a set of point of sale peripheral connector 210. Members of the set of point of sale peripheral connectors 210 are connected to a set of point of sale peripheral devices 299. In one example, each member of the set of point of sale peripheral connectors 210 may be connected to a single member of the set of point of sale peripheral devices 299. In other examples, multiple point of sale peripheral devices 299 may be connected to a single peripheral connector 210, or multiple peripheral connectors 210 may connect to a single peripheral device 299. Point of sale peripheral connectors may be, for example, universal serial bus connectors, serial connectors (e.g., RS232, or other types of connectors. The point of sale peripheral devices 299 may include for example, a printer, a display, a barcode scanner, a cash drawer, a magnetic stripe reader, a keyboard, a mouse, a scale, a fingerprint reader, and so forth.

System 200 also includes a remote device interface 220. Remote device interface 220 connects system 200 to a set of remote devices 290. In this example, one remote device interface 220 is connected to several remote devices 290, though in other examples, multiple remote device interfaces 220 may connect to members of the set of remote devices 290 in various combinations. Members of the set of remote devices 290 may operate respective point of sale modules. Members of the set of remote devices may include, for example, mobile devices (e.g., phone, laptop, tablet), fixed devices (e.g., desktop pc), other custom point of sale devices, and so forth. Consequently, the remote device interface may be, for example, an Ethernet connection, a Bluetooth connection, a wireless local area network connection, and so forth.

System 200 also includes a point of sale peripheral control module 230. Point of sale peripheral control module 230 may provide signals controlling operation of members of the set of point of sale peripheral devices 299 to the members of the set of point of sale peripheral devices 299. Point of sale peripheral control module 230 may also receive signals from the members of the set of point of sale peripheral devices 299. In this example, point of sale peripheral control module 230 provides signals to and receives signals from point of sale peripheral devices 299 via point of sale peripheral connectors 210 to which respective members of the set of point of sale peripheral devices 299 are connected.

System 200 also includes an interface module 240. Interface module 240 may translate signals between formats used by members of the set of point of sale peripheral devices 299 and members of the set of remote devices 290. As discussed above, interface module 240 may communicate with remote devices via an application programming interface and with point of sale peripheral devices 299 according to a standard (e.g., the unified point of sale standard, a proprietary standard). Consequently interface module 240 may translate between these two standards allowing newer devices 290 (e.g., mobile devices) to interface smoothly with legacy point of sale peripherals.

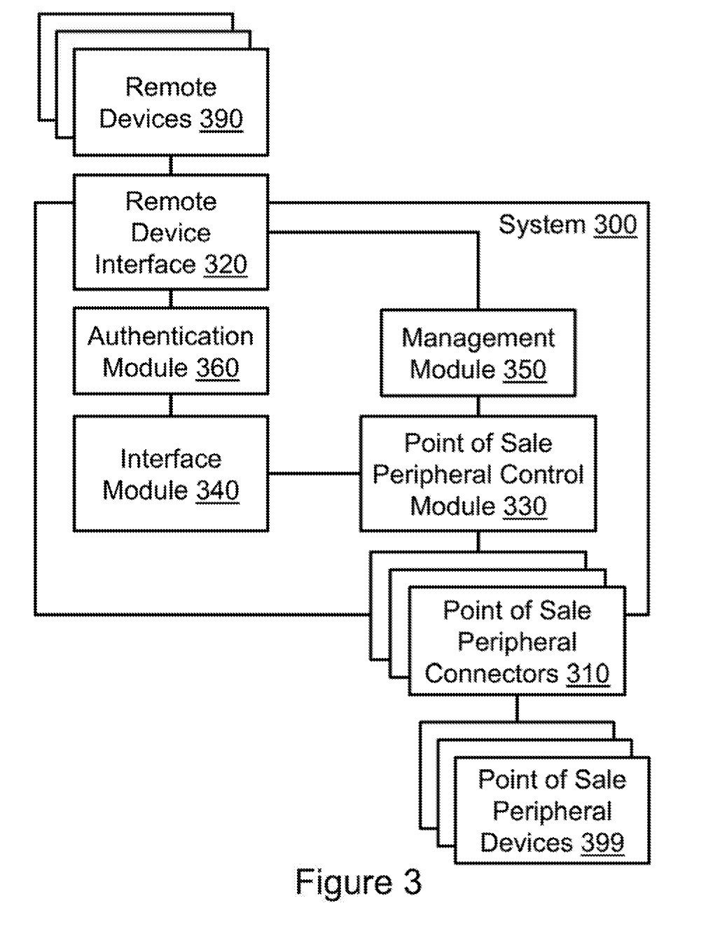

FIG. 3 illustrates a system 300 associated with point of sale peripheral control. System 300 includes several items similar to those described above with reference to system 200 (FIG. 2). For example, system 300 includes a set of point of sale peripheral connectors 310 to connect system 300 to a set of point of sale peripheral devices 399, a remote device interface 320 to connect system 300 to a set of remote devices 390, an interface module 340 and a point of sale peripheral control module 330.

System 300 also includes a management module 350. Management module 350 may monitor statuses of members of the set of point of sale peripheral devices 399. Management module 350 may also provide statuses of members of the set of point of sale peripheral devices 399 to a member of the set of remote devices 390. Providing statuses to the member of the set of remote devices 390 may allow that member to, for example, identify a peripheral device 399 available for use, identify a failure of a peripheral device 399, and so forth.

System 300 also includes an authentication module 380. Authentication module 360 may selectively control access of a member of the set of remote devices 390 to a member of the set of point of sale peripheral devices 399. Access may be selectively controlled based on a credential provide by the member of the set of remote devices 390. Authentication module may control access to peripheral devices 399 based on a credential of a user provided by a remote devices 390, by a credential associated with a remote device 390 itself, a combination, and so forth. This may facilitate preventing unauthorized use of point of sale peripheral devices 399, providing emergency access to point of sale peripheral devices 399, and so forth. By way of illustration, ensuring a user is properly credentialed, a retailer may prevent improper access to, for example, a cash drawer.

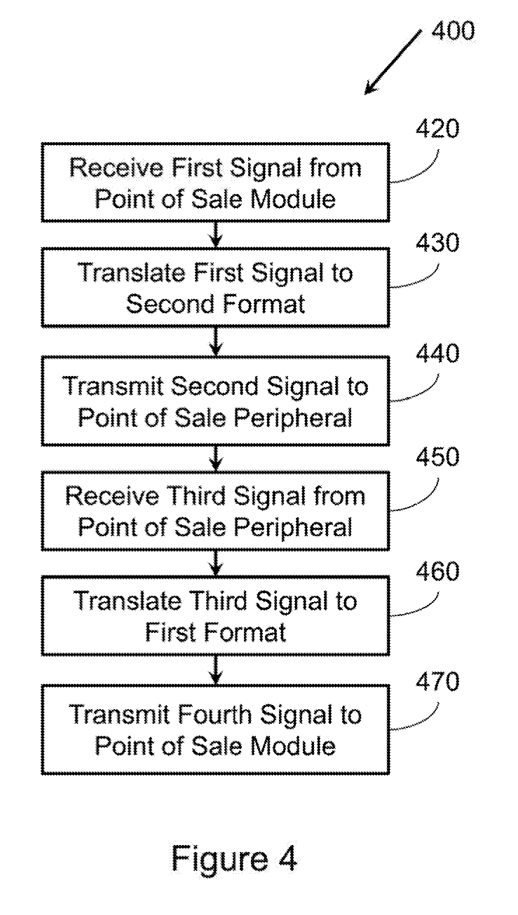

FIG. 4 illustrates an example method 400 associated with point of sale peripheral control. Method 400 may be embodied on a non-transitory computer-readable medium storing processor-executable instructions. The instructions, when executed by a processor, may cause the processor to perform method 400. In other examples, method 400 may exist within logic gates and/or RAM of an application specific integrated circuit (ASIC).

Method 400 includes receiving a first signal from a point of sale module on a remote device at 420. The first signal may have a first format. The first signal may be generated based on a command input to the remote device by, for example, a user via a user interface. The command may be converted to the first format according to an application programming interface built into the point of sale module on the remote device. Thus, the first signal may encompass a command directed to a point of sale peripheral device. The command may cause the point of sale peripheral device to perform some function, obtain some information, temporarily link the point of sale module and/or remote device to the point of sale peripheral, and so forth.

Method 400 also includes translating the first signal to a second signal in a second format at 430. The second format may be usable to control a point of sale peripheral device. The second format may implement a unified point of sale standard. This may allow the command provided by the point of sale module on the remote device to be understood by the point of sale peripheral. Method 400 also includes transmitting the second signal to a point of sale peripheral device at 440.

Method 400 also includes receiving a third signal from the point of sale peripheral device at 450. The third signal may have the second format. In various examples, the third signal may be in some way responsive to the second signal. By way of illustration if the second signal requests information from a point of sale peripheral, the third signal may include that information. In another example, if the second signal causes opening of a cash drawer, the third signal may acknowledge the opening of the cash drawer, confirm closing of the cash drawer, and so forth,

Method 400 also includes translating the third signal into a fourth signal having the first format at 460. Method 400 also includes transmitting the fourth signal to the point of sale module at 470. The fourth signal may be used by the point of sale module to, for example, maintain records associated with a transaction, provide information to a user (e.g., a store employee) of the remote device (e.g., via a display on the remote device), and so forth.

In various examples, actions described in association with method 400 may be performed in a variety of orderings. For example, as illustrated, the signals are received and sent sequentially from first through fourth. In an alternative example, there may be situations where the actions associated with the third and fourth signals are performed before the actions associated with the first and second signals. This may occur, for example, when a point of sale peripheral initiates a communication with the remote device. By way of illustration, this may occur when a bar code scanner scans a bar code to be read by the point of sale module on the remote device, after which the remote device may, for example, acknowledge to the bar code scanner that the bar code has been successfully received. Other orderings of the actions associated with method 400 may also be possible.

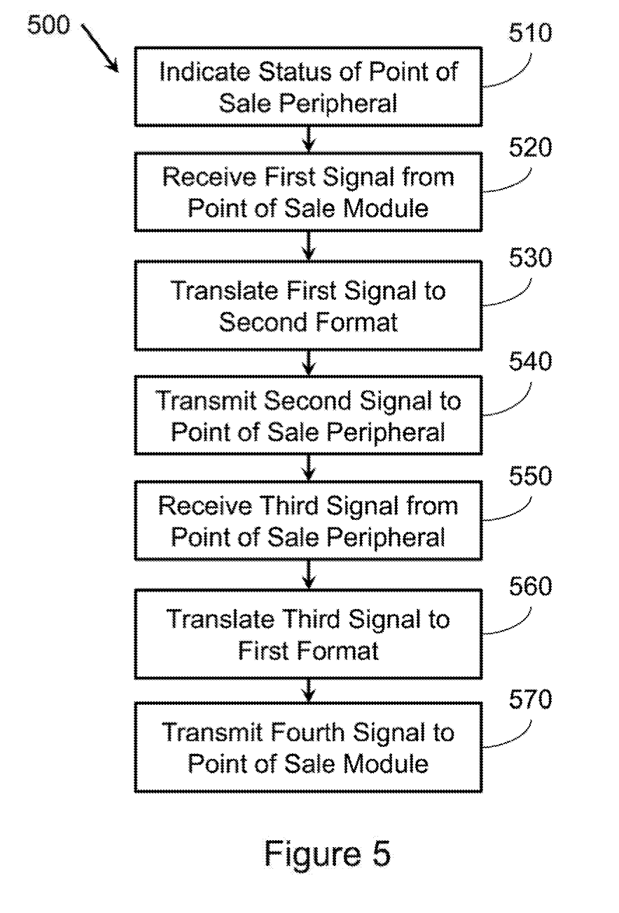

FIG. 5 illustrates a method 500 associated with point of sale peripheral control. Method 500 includes several actions similar to those described above with reference to method 400 (FIG. 4). For example, method 500 includes receiving a first signal from a point of sale module in a first format at 520, translating the first signal to a second signal in a second format at 530, transmitting the second signal to a point of sale peripheral at 540, receiving a third signal from a point of sale peripheral at 550, translating the third signal into fourth signal in the first format at 560, and transmitting the fourth signal to a point of sale module at 570.

Method 500 also includes indicating status of the point of sale peripheral device at 510. The status may be indicated to the point of sale module. The status may be, for example, a location of the point of sale peripheral device, an operating condition of the point of sale peripheral device, an error state of the point of sale peripheral device, and so forth. In one example, the point of sale peripheral device may be a member of a set of point of sale peripheral devices having similar functionality (e.g., a set of barcode scanners). In this example, the status provided may be a location of the point of sale peripheral device. Further, the point of sale peripheral device may have been selected based on a physical proximity between the remote device and members of the set of point of sale peripheral devices.

Indicating statuses of point of sale peripherals to point of sale modules may facilitate, sharing of point of sale peripherals between remote devices. This may be desirable in, for example, where a retailer's employees use mobile devices as point of sale terminals in a manner that allows the employees to complete sales transactions throughout the floor space of the retailer to efficiently assist customers with whatever issues those customers may have.

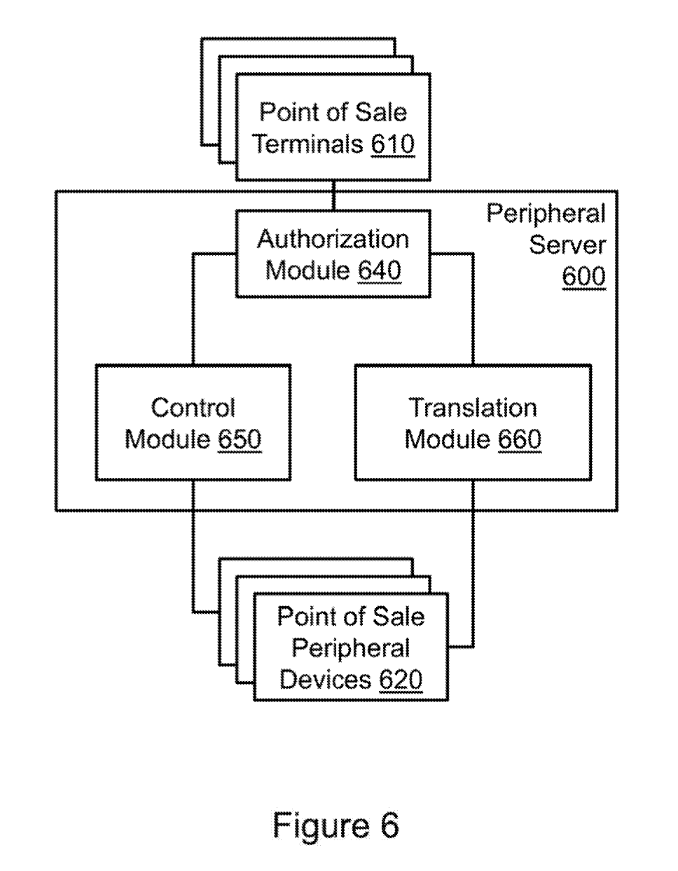

FIG. 6 illustrates a peripheral server 600 associated with point of sale peripheral control. In some examples, peripheral server 600 may be a computer in the process of executing computer-executable instructions read from a non-transitory computer-readable medium. The computer-executable instructions may cause peripheral server 600 to perform various functions in association with point of sale peripheral control. In this example, functions have been organized into a number of modules for clarity. However, other groupings of functions into a different set of modules may also be possible.

Peripheral server 600 is connected to a set of point of sale terminals 610. The point of sale terminals 610 may be, for example, computers, mobile devices, custom point of sale terminals, and so forth. Peripheral server 600 is also connected to a set of point of sale peripheral devices 620. Point of sale peripheral devices 620 may include, for example, displays, receipt printers, barcode scanners, and so forth.

In various examples,peripheral server 600 may serve as an interface between the point of sale terminals 610 and point of sale peripheral devices 620. Peripheral server 600 includes an authorization module 640. Authorization module 640 may manage communication permissions between members of the set of point of sale terminals 610 and members of the set of point of sale peripheral devices 620. In various examples, authorization module 640 may manage communication permissions based on credentials provided to authorization module 640 from point of sale terminals 610. The credentials may be associated with point of sale terminals 610 themselves, users of point of sale terminals 610, and so forth. In this example, authorization module 640 may act as a gateway between point of sale terminal 610 and other components of the peripheral server 600, and point of sale peripheral devices 620. Thus, authorization module 640 may prevent unauthorized use of point of sale peripheral devices 620, and so forth.

Peripheral server 600 also includes a control module 650. Control module 650 may receive a first signal from a member of the set of point of sale terminals 610. Subsequently, control module 650 may format the first signal into a control signal that controls operation of a member of the set of point of sale peripheral devices 620. Control module 650 may then provide the control signal to the member of the set of point of sale peripheral devices 620. The control signal may cause the member of the set of point of sale peripheral devices 620 to perform a function, provide information, and so forth.

Peripheral server 600 also includes a translation module 660. Translation module 660 may receive a response signal from the member of the set of point of sale peripheral device 620. The response signal may be received in response to the control signal. Translation module 660 may then translate the response signal to a second signal having a format recognizable by the member of the set of point sale terminals 610. Translation module 660 may also provide the second signal to the member of point of sale terminals 610.

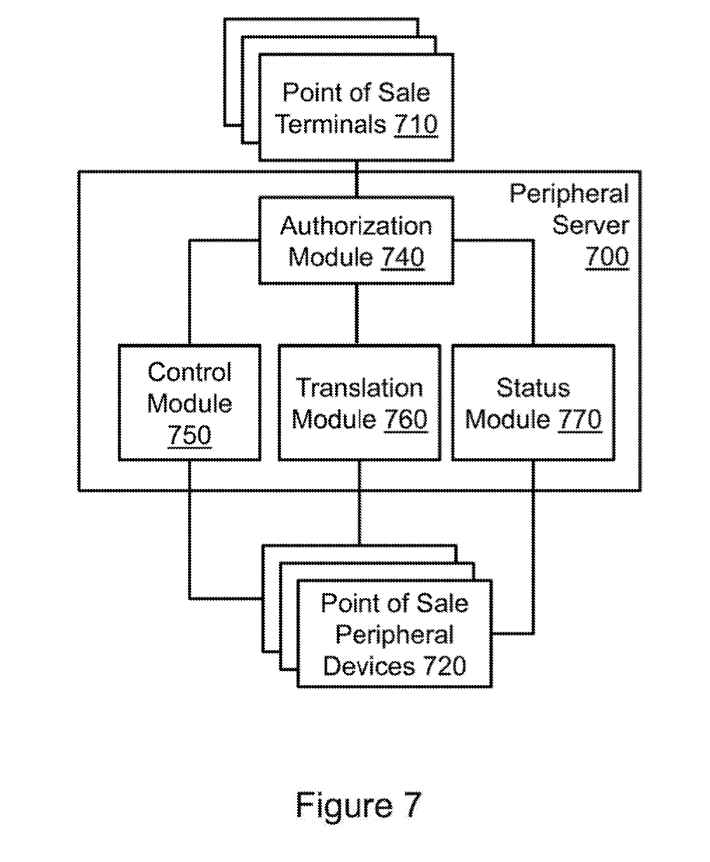

FIG. 7 illustrates a peripheral server 700 associated with point of sale peripheral control. Peripheral server 700 includes several items similar to those described above with reference to peripheral server 600 (FIG. 6). For example, peripheral server 700 is connected to a set of point of sale terminals 710, and a set of point of sale peripheral devices 720. Further, peripheral server 700 includes an authorization module 740, a control module 750, and a translation module 760. As above, peripheral server 700 may be in the process of executing instructions read from a non-transitory computer-readable medium.

Peripheral server 700 also includes a status module 770. Status module 770 may receive status signals from members of the set of point of sale peripheral devices 720. Status module 770 may also provide status information regarding members of the set of point of sale peripheral devices 720 to the member of the set of point of sale terminals 710. The status information may be derived from the status signals. The member of the set of point of sale terminals 710 may monitor availability of members of the set of point of sale peripheral devices 720 using the status information. Monitoring availability of members of the set of point of sale peripheral device 720 may facilitate sharing of members of the set of point of sale peripheral devices 720 between members of the set of point of sale terminals 710.

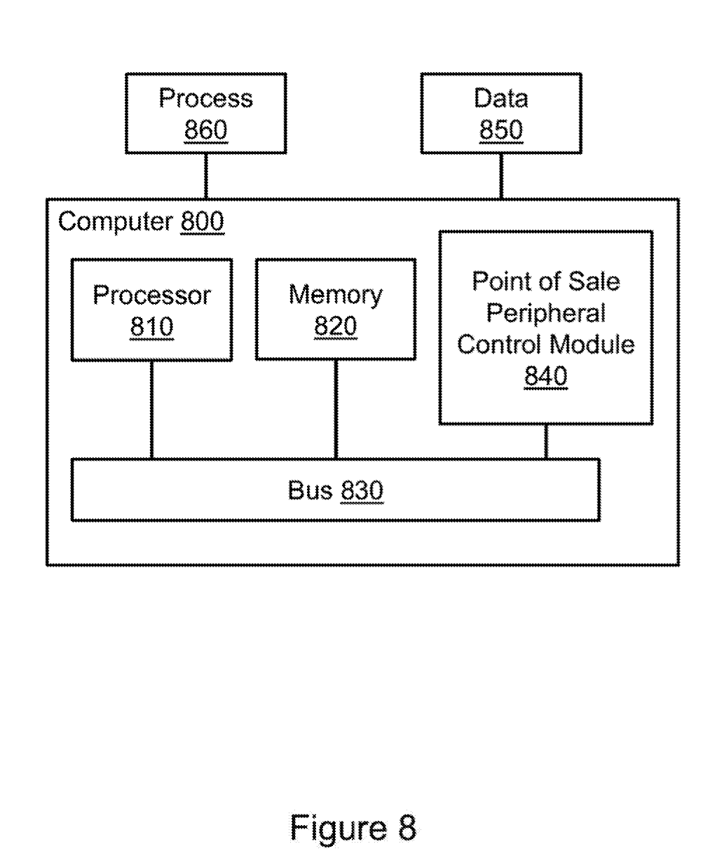

FIG. 8 illustrates an example computing device in which example systems and methods, and equivalents, may operate. The example computing device may be a computer 800 that includes a processor 810 and a memory 820 connected by a bus 830. Computer 800 includes a point of sale peripheral control module 840. Point of sale peripheral control module 840 may perform, alone or in combination, various functions described above with reference to the example systems, methods, apparatuses, and so forth. In different examples, point of sale peripheral control 840 may be implemented as a non-transitory computer-readable medium storing processor-executable instructions, in hardware, software, firmware, an application specific integrated circuit, and/or combinations thereof.

The instructions may also be presented to computer 800 as data 850 and/or process 860 that are temporarily stored in memory 820 and then executed by processor 810. The processor 810 may be a variety of processors including dual microprocessor and other multi-processor architectures. Memory 820 may include non-volatile memory (e.g., read only memory) and/or volatile memory (e.g., random access memory). Memory 820 may also be, for example, a magnetic disk drive, a solid state disk drive, a floppy disk drive, a tape drive, a flash memory card, an optical disk, and so on. Thus, memory 820 may store process 868 and/or data 850. Computer 800 may also be associated with other devices including other computers, computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A system, comprising:
a set of point of sale peripheral connectors to which a set of point of sale peripheral devices are connected;
a remote device interface to communicate with a set of remote devices, where members of the set of remote devices operate respective point of sale modules;
a point of sale peripheral control module to provide signals controlling operation of members of the set the point of sale peripheral devices to the members of the set of point of sale peripheral devices, and to receive signals from the members of the set of point of sale peripheral devices; and
an interface module to translate signals between formats used by embers of the set of point of sale peripheral devices, and members of the set of remote devices.

2. The system of claim 1, comprising a management module to monitor statuses of the members of the set of point of sale peripheral devices and to provide the statuses of the members of the set of point of sale peripheral devices to a remember of the set of remote devices.

3. The system of claim 1, comprising an authentication module to selectively control access of a member of the set of remote devices to a member of the set of point of sale peripheral devices based on a credential provided by the member of the set of remote devices.

4. The system of claim 1, where a point of sale peripheral connector is of a universal serial bus connector and a serial connector.

5. The system of claim 1, where the set of point of sale peripheral devices comprises one of a printer, a display, a barcode scanner, a cash drawer, a magnetic stripe reader, a keyboard, a mouse, a scale, and a fingerprint reader.

6. The system of claim 1, where a member of the set remote devices is one of a mobile device and a fixed device.

7. The system of claim 1, where the remote device interface is of an Ethernet connection, a Bluetooth connection, and a wireless local area network connection.

8. A method, comprising:
receiving a first signal in a first format from a point of sale module on a remote device;
translating the first signal to a second signal in a second format, the second format usable to control a point of sale peripheral device;
transmitting the second signal to the point of sale peripheral device;
receiving a third signal in the second format from the point of sale peripheral device;
translating the third signal into a fourth signal in the first format; and
transmitting the fourth signal to the point of sale module.

9. The method of claim 8, where the second format implements a unified point of sale standard.

10. The method of claim 8, comprising indicting a status of the point of sale peripheral device to the point of sale module.

11. The method of claim 10, where the status is one of, a location of the point of sale peripheral device, an operating condition of the point of sale peripheral device, and an error state of the point of sale peripheral device.

12. The method of claim 10, where the point of sale peripheral device is a member of a set of point of sale peripheral devices having similar functionality, and status of the point of sale peripheral is a location of the point of sale peripheral device, where the point of sale peripheral device has been selected based on a physical proximity between the remote device and members of the set of point of sale peripheral devices.

13. A non-transitory computer-readable medium storing computer-executable instructions that when executed by a computer cause the computer to:
manage communication permissions between members of a set of point of sale terminals and members of a set of point of sale peripheral devices;
receive a first signal from a member of the set of point of sale terminals;
format the first signal into a control signal that controls operation of the member of the set of point of sale peripheral devices;
provide the control signal to the member of the set of point of peripheral devices;
receive a response signal in response to the control signal from the member of the set of point of sale peripheral devices;
translate the response signal to a second signal having a format recognizable by the member of the set of point of sale terminals; and
provide the second signal to the member of the set of point of sale terminals.

14. The non-transitory computer-readable medium of claim 13, where the instructions further cause the computer to:
receive status signals from members of the set of point of sale peripheral devices; and
provide status information regarding members of the set of point of sale peripheral devices to the member of the set of point of sale terminals, where the status information is derived from the status signals.

15. The non-transitory computer-readable medium of claim 13, where the status information facilitates sharing members of the set of point of sale peripheral devices between members of the set of point of sale terminals.
